(19) United States
(12) Patent Application Publication
(10) Pub. No.: US 2024/0308928 A1
(43) Pub. Date: Sep. 19, 2024

(54) KAOLINE BINDERS FOR FERTILIZERS

(71) Applicant: ICL EUROPE COOPERATIEF U.A., Amsterdam (NL)

(72) Inventor: Khalil ABU-RABEAH, Beer Sheva (IL)

(21) Appl. No.: 18/271,457

(22) PCT Filed: Nov. 26, 2021
(86) PCT No.: PCT/IL2021/051412

§ 371 Date: Jul. 9, 2023

Related U.S. Application Data
(60) Provisional application No. 63/149,667, filed on Feb. 16, 2021.

(51) Int. Cl. C05D 1/02; C05B 1/02; C05D 1/00; C05D 3/02; C05G 5/12; C05G 5/40

(52) U.S. Cl. CPC C05D 1/02; C05B 1/02; C05D 1/005; C05D 3/02; C05G 5/12; C05G 5/40

(57) ABSTRACT

According to some embodiments. there is provided herein a compacted granule of Poly halite with one or more potassium salts and a binder having a strength of at least 2.2 kg/granule when measured 7 days after production.

### FIELD OF THE INVENTION

The present invention relates to the field of composite fertilizers, specifically to the production of a fertilizer containing polyhalite and potassium salts.

### BACKGROUND OF THE INVENTION

To grow properly, plants need nutrients (nitrogen, potassium, calcium, zinc, magnesium, iron, manganese, etc.) which normally can be found in the soil. Sometimes fertilizers are needed to achieve a desired plant growth as these can enhance the growth of plants.

This growth of plants is met in two ways, the traditional one being additives that provide nutrients. The second mode by which some fertilizers act is to enhance the effectiveness of the soil by modifying its water retention and aeration. Fertilizers typically provide, in varying proportions, three main macronutrients:

Nitrogen (N): leaf growth;

Phosphorus (P): Development of roots, flowers, seeds, fruit;

Potassium (K): Strong stem growth, movement of water in plants, promotion of flowering and fruiting;

three secondary macronutrients: calcium (Ca), magnesium (Mg), and sulphur (S);

micronutrients: copper (Cu), iron (Fe), manganese (Mn), molybdenum (Mo), zinc (Zn), boron (B), and of occasional significance there are silicon (Si), cobalt (Co), and vanadium (V) plus rare mineral catalysts.

The most reliable and effective way to make the availability of nutrients coincide with plant requirements is by controlling their release into the soil solution, using slow release or controlled release fertilizers.

Both slow release fertilizers (SRF) and controlled release fertilizers (CRF) supply nutrients gradually. Yet, slow release fertilizers and controlled release fertilizers differ in many ways:

The technology they use, the release mechanism, longevity, release controlling factors and more.

Solid fertilizers include granules, prills, crystals and powders. A prilled fertilizer is a type of granular fertilizer that is nearly spherical made by solidifying free-falling droplets in air or a fluid medium. Most controlled-release fertilizers (CRFs) used in commercial nurseries are prilled fertilizers that have been coated with sulfur or a polymer. These products have been developed to allow a slow release of nutrients into the root zone throughout crop development.

Polyhalite is an evaporite mineral, a hydrated sulfate of potassium, calcium and magnesium with formula: K₂Ca₂Mg(SO₄)₄·2H₂O. Polyhalite is used as a fertilizer since it contains four important nutrients and is low in chloride:

48% SO₃ as sulfate

14% K₂O

6% MgO

17% CaO

### SUMMARY OF THE INVENTION

According to some embodiments, there is provided herein a compacted granule of Polyhalite with one or more potassium salts and a binder having a strength of at least 2.2 kg/granule when measured 7 days after production.

According to some embodiments, the one or more potassium salts is selected from the group including KCl, K₂SO₄, KH₂PO₄, K₂CO₃, KHCO₃, KNO₃.

According to some embodiments, the one or more potassium salts is Potash.

According to some embodiments, the binder is selected from the group including Kaoline and Metakaoline.

According to some embodiments, the binder is in a concentration of 1-4% w/w.

According to some embodiments, the binder is mixed with an alkali binder, for example Ca(OH)₂, KOH, NaOH and the like.

According to some embodiments, the binder is further mixed with Sodium Hexametaphosphate.

According to some embodiments, there is provided herein a process for the compaction of a granule including: Mixing Polyhalite and one or more Potassium salts; Adding a binder in a concentration of 1-4% w/w; Adding water 0.5-5% w/w; Mixing the polyhalite, potassium salt, water and binder for 5 minutes to provide a mixture; Transferring the mixture to compactor having press of 40-80 kN/cm, to provide initial granules;

Crushing and then sieving the initial granules to desirable range of 2-4.75 mm.

According to some embodiments, the process further including transferring any initial granule smaller than 2 mm back to the feed and any oversized initial granules having a size of over 4.75 mm to the crusher.

According to some embodiments, the one or more potassium salts is selected from the group including KCl, K₂SO₄, KH₂PO₄, K₂CO₃, KHCO₃, KNO₃.

According to some embodiments, the one or more potassium salts is Potash.

According to some embodiments, the binder is selected from the group including Kaoline and Metakaoline.

### DETAILED DESCRIPTION OF THE INVENTION

According to some demonstrative embodiments, there is provided herein a granule of two fertilizers or more in a ratio of between 2:1 to 1:2, preferably 1:1.

According to some demonstrative embodiments, the term “fertilizer” may include any material of natural or synthetic origin that is applied to soils or to plant tissues to supply one or more plant nutrients essential to the growth of plants, including, for example, Single nutrient (“straight”) fertilizers such as Ammonium nitrate, Urea, calcium ammonium nitrate, superphosphate, e.g., “Single superphosphate” (SSP), phosphogypsum, Triple superphosphate (TSP) or a mixture thereof; Multinutrient fertilizers such as Binary (NP, NK, PK) fertilizers, e.g., monoammonium phosphate (MAP) and/or diammonium phosphate (DAP), NPK fertilizers which are three-component fertilizers providing nitrogen, phosphorus, and potassium; fertilizers which include one or more of the main micronutrients sources of iron, manganese, boron, molybdenum, zinc, and copper and the like; Compound fertilizers, e.g., which contain N, P, and K; Organic fertilizers such as peat, animal wastes, plant wastes from agriculture, and sewage sludge; and/or Other elements such as calcium, magnesium, and sulfur.

According to some demonstrative embodiments, there is provided herein a granule of Polyhalite and one or more potassium salts in a ratio of between 2:1 to 1:2, preferably 1:1.

According to some demonstrative embodiments, the term “potassium salts” may refer to one ore more salts from the group including: KCl, K₂SO₄, KH₂PO₄, K₂CO₃, KHCO₃, KNO₃.

According to some demonstrative embodiments, the preferable potassium salts may be Potash.

According to some demonstrative embodiments, the granule may comprise a binder in a concentration of 1-4% w/w, preferably 2% w/w.

According to some embodiments, the binder may selected from the group including Kaoline and Metakaoline.

According to some demonstrative embodiments, the binder of the present invention may be mixed with and Ca(OH)₂ and/or Sodium Hexametaphosphate, e.g., to yield optimal results.

According to some embodiments, SHMP can act as sequestering agent for Ca and Mg, thereby beneficially affecting compacted yield.

According to some embodiments, the binder may preferably be Kaoline, more preferably, the binder may include a binder mix of Kaoline, Ca(OH)₂ and sodium hexametaphosphate (“SHMP”).

According to some embodiments, the binder mix may include the following concentrations: Kaoline 1-4% w/w from the total composition, preferably 2% w/w from the total composition, Ca(OH)₂ in a concentration of between 2-4% w/w from the total composition, preferably 2.3% w/w from the total composition, and sodium hexametaphosphate SHMP 1% w/w from the total composition.

According to some demonstrative embodiments, it is considered difficult to compact Polyhalite with potassium salts, such as Potash, due to opposing electrical charges which cause Polyhalite and the potassium salt to repel each other.

According to some embodiments, this drawback may be overcome by using a kaoline binder, especially with the addition of an alkali substance, e.g., Ca(OH)₂ which activates the Kaoline.

According to some embodiments, it is estimated that the Calcium hydroxide may facilitate the formation of a hydrogen bond bridge between the silicate of the Kaoline binder the surface of the potassium salts.

The result is a stronger bond between substances which repel each other.

According to some embodiments, the granule of the present invention may include ana dditional binder selected from the group including, but not limited, any suitable material or compound that may mechanically and/or chemically hold or draw other materials together to form a cohesive whole, including, for example, organic or inorganic binders, such as, starch, bentonite, Lignosulfonates, molasses, hydrated lime, bitumen, Portland cement, clay, acids (Nitric, Hydrochloric, Phosphoric, Sulphuric), Cellulose Gum, Sucrose, HD-50R, Water Glass (Na₂SIO₃), Cements, Fly Ash, volcanic ash wood ash Potassium and Sodium Silicate, MgO, CaO, Alganite, PEG, Fly Ash, Pozzolanic additive, Geo-polymers, Oils and Waxes and the like, or a combination thereof.

According to some embodiments, there is provided herein a process for the compaction of a granule including:

Mixing the dry materials, i.e., Polyhalite and the Potassium salts for 2-7 minutes, preferably for 5 minutes;

Adding a binder in a concentration of 1-4% w/w preferably 2% w/w;

Adding water 0.5-5% w/w preferably 2.5% w/w

Mixing the polyhalite, potassium salt, water and binder for 5 minutes to provide a mixture;

Transferring the mixture to compactor having press of 40-80 kN/cm, preferably 50 kN/cm, linear velocity between 0.1 to 1.2 m/s, to provide initial granules;

Crushing and then sieving the initial granules to desirable range of 2-4.75 mm.

Transferring any initial granule smaller than 2 mm back to the feed and any oversized initial granules having a size of over 4.75 mm to the crusher

Any remaining granules are the desired granules of the present invention.

According to some demonstrative embodiments, the granule of the present t invention may also include one or more micronutrients selected from the group including: copper (Cu), iron (Fe), manganese (Mn), molybdenum (Mo), zinc (Zn), boron (B), silicon (Si), cobalt (Co), and vanadium (V).

### EXAMPLES

### Example-1

2500 gram of polyhalite was mixed with 2500 gr of potash. 2% w/w of kaolin and 2.3% wt of Ca(OH)₂ was added to the mix and mixed for 5 minutes. Water was added at a concentration of 0.5% w/w and the mixture was mixed for 5 more minutes. The resulting mixture was transferred to a compactor operated at 50 kN/cm and 0.1 m/s.

Yield—15%

Initial strength—1.2 kg/granule

Strength after 7 days—3.0 kg/granule

Final moisture—0.45%

Attrition—12 mesh—19%

Eco Dust—0.76%

### Example-2

As in example 1

Added water—1% w/w

Yield—18%

Initial strength—2.2 kg/granule

Strength after 7 days—3.4 kg/granule

Final moisture—0.7%

Attrition—12 mesh—11%

Eco Dust—0.74%

### Example-3

As in example 1

Added water—1.5% w/w

Yield—18%

Initial strength—1.3 kg/granule

Strength after 7 days—4.3 kg/granule

Final moisture—1.25%

Attrition—12 mesh—11%

Eco Dust—0.90%

### Example 4

As in example 1

Binder SHMP—1% w/w

Added water—1% v/w

Yield—23%

Initial strength—2.5 kg/granule

Strength after 7 days—2.2 kg/granule

Final moisture—0.6

Attrition—12 mesh—23%

Eco Dust—1.1%

While this invention has been described in terms of some specific examples, many modifications and variations are possible. It is therefore understood that within the scope of the appended claims, the invention may be realized otherwise than as specifically described.

1. A compacted granule of Polyhalite with one or more potassium salts and a binder having a strength of at least 2.2 kg/granule when measured 7 days after production.

2. The granule of claim 1, wherein said one or more potassium salts is selected from the group including KCl, K₂SO₄, KH₂PO₄, K₂CO₃, KHCO₃, KNO₃.

3. The granule of claim 2, wherein said one or more potassium salts is Potash.

4. The granule of claim 1, wherein said binder is selected from the group including Kaoline and Metakaoline.

5. The granule of claim 4, wherein said binder is in a concentration of 1-4% w/w.

6. The granule of claim 4, wherein said binder is mixed with Ca(OH)₂.

7. The granule of claim 6, wherein said binder is further can mixed with Sodium Hexametaphosphate.

8. A process for the compaction of a granule including:
Mixing Polyhalite and one or more Potassium salts;
Adding a binder in a concentration of 1-4% w/w;
Adding water 0.5-5% w/w;
Mixing the polyhalite, potassium salt, water and binder for 5 minutes to provide a mixture;
Transferring the mixture to compactor having press of 40-80 kN/cm, to provide granules;
Crushing and then sieving the granules to desirable range of 2-4.75 mm.

9. The process of claim 8, further including transferring any granule smaller than 2 mm back to the feed and any oversized granules having a size of over 4.75 mm to the crusher.

10. The process of claim 8, wherein said one or more potassium salts is selected from the group including KCl, K₂SO₄, KH₂PO₄, K₂CO₃, KHCO₃, KNO₃.

11. The process of claim 10, wherein said one or more potassium salts is Potash.

12. The process of claim 8, wherein said binder is selected from the group including Kaoline and Metakaoline.
